(19) United States
(12) Patent Application Publication
(10) Pub. No.: US 2002/0042251 A1
(43) Pub. Date: Apr. 11, 2002

(54) Cellular phone ornament structure

(76) Inventor: Mark Tsai, Taipei (TW)

Correspondence Address: BACON & THOMAS, PLLC, 625 SLATERS LANE, FOURTH FLOOR, ALEXANDRIA, VA, 22314

(21) Appl. No.: 09/880,069

(22) Filed: Jun. 14, 2001

(30) Foreign Application Priority Data
Sep. 30, 2000 (TW) 89217010

(51) Int. Cl. H04B 1/38

(52) U.S. Cl. 455/90; 455/550; 455/66

(57) ABSTRACT

The present invention relates to a cellular phone ornament structure wherein cellular phones can be placed into different models. The present invention mainly consists of a cellular phone and an assembling stand. The cellular phone is not limited to firm brands or model types and length or size is based on size of a hand; the inner part of the assembling stand is in form of a box and consists of a group of elastic bands and several springs whereas the outer part is of one particular size and can be fitted into empty bodies of specially designed models. The present invention is thus a convenient way of changing phone ornaments according to one's personal taste and style.

The present invention relates to a cellular phone ornament structure wherein cellular phones can be placed into different models.

### INVENTION BACKGROUND

Commonly used cellular phone ornaments are usually limited to only one kind of firm brand and cannot be changed in forms and appearances. Hence, one has to buy different cellular phones to satisfy the need of novelty. This situation is quite inconvenient as one has to bring different cellular phones when going out and cost of basic fee is also increased.

Nowadays, cellular phones are designed in size and appearance and in order to meet society's demand of novelty, the present invention combines a model and a cellular phone enabling the model fan to play with his model at any time while making full use of his phone. The present invention is thus very original and the users does not have to pay for rental fee of different cellular phone numbers.

### SUMMARY OF INVENTION

The present invention relates to a cellular phone ornament structure wherein any cellular phone can be economically and originally owned according to one's like.

The present invention relates to a cellular phone ornament structure wherein model factories can produce their models on a basic specification and increase their sales, being considerate to their clients and at the same time advertising.

### DESCRIPTION OF DRAWING

FIG. 1 shows the assembling of the present invention.

NUMERICALS

| | |
|---|---|
| 11-cellular phone | 12-assembling stand |
| 13-elastic bands | 14-springs |
| 15-model | 16-empty body |
| 17-cellular phone antenna | |

### MODEL FOR CARRYING OUT INVENTION

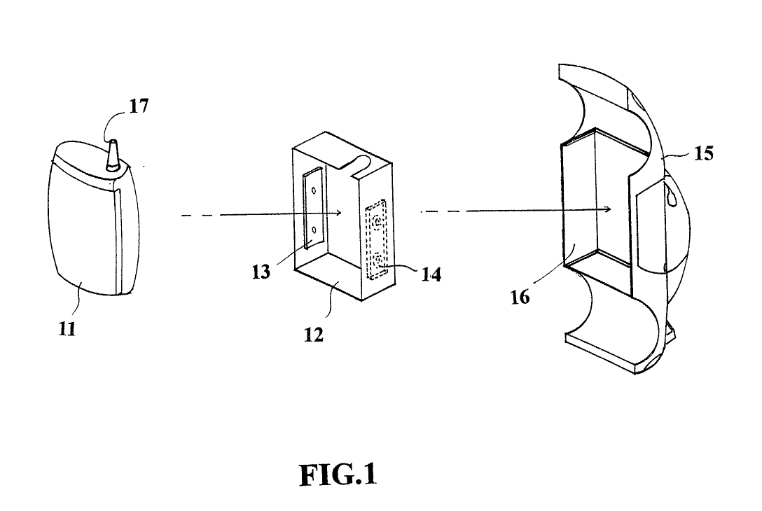

With reference to FIG. 1 showing the assembling of the present invention, the cellular phone 11 is not limited to firm brands or model types and length or size is based on the size of a hand. The inner side of the assembling stand 12 is in form of a box and consists of elastic bands 13 and several springs 14 whereas the outer part is of one particular size and can be fitted into empty bodies 16 of specially designed models 15.

With further reference to FIG. 1, cellular phone 11 is placed into assembling stand 12 and secured by a group of elastic bands 13 and can be taken out by pulling at the cellular phone antenna 17. It can also be placed in the empty body 16 of specially designed model 15.

With more reference to FIG. 1, if cellular phone 11 rings when it is assembled in model 15, it is the best time to show-off and publicize.

1. A cellular phone ornament structure mainly comprising of a cellular phone and an assembling stand wherein:
The cellular phone is not limited in firm brands or model types and length or size is based on the size of a hand;
The inner part of the assembling stand is in form of a box and consists of a group of elastic bands and several springs whereas the outer part is of one particular type and can be fitted into empty bodies of specially designed models.
